(19) United States
(12) Patent Application Publication
(10) Pub. No.: US 2026/0370732 A1
(43) Pub. Date: Nov. 19, 2026

(54) COMMUNICATION SERVICE SYSTEM, METHOD FOR IMPLEMENTING COMMUNICATION SERVICE, DEVICE AND STORAGE MEDIUM

(71) Applicant: CLOUD INTELLIGENCE ASSETS HOLDING (SINGAPORE) PRIVATE LIMITED, Singapore (SG)

(72) Inventors: Xiaocheng LI, Hangzhou, Zhejiang (CN); Geng LI, Hangzhou, Zhejiang (CN)

(21) Appl. No.: 19/126,565

(22) PCT Filed: Nov. 15, 2023
(86) PCT No.: PCT/CN2023/131853

§ 371 Date: May 1, 2025

(30) Foreign Application Priority Data
Nov. 15, 2022 (CN) 202211430970.6

(51) Int. Cl. H04L 67/60

(52) U.S. Cl. CPC H04L 67/60

(57) ABSTRACT

The present disclosure provides a communication service system, which includes a central control and management device and at least one edge cloud node. The central control and management device is configured to, in response to a communication service request initiated for a destination device, determine a target edge cloud node corresponding to the destination device among at least one edge cloud node according to a preset resource scheduling strategy, and schedule the communication service request to the target edge cloud node. The target edge cloud node is configured to forward the received communication service request to an operator network, so that the operator network triggers an establishment of a communication connection between the central control and management device and the destination device based on the communication service request.

### CROSS-REFERENCE TO RELATED APPLICATIONS

The present disclosure is a National Stage of International Application No. PCT/CN2023/131853, filed on Nov. 15, 2023, which claims the priority of Chinese patent application No. 202211430970.6, filed in China National Intellectual Property Administration on Nov. 15, 2022, and titled “communication service system, method for implementing communication service, device and storage medium”, the entire contents of these applications are incorporated into the present disclosure by reference.

### TECHNICAL FIELD

The present disclosure relates to the technical field of communication, in particular to a communication service system, a method for implementing communication service, a device and a storage medium.

### BACKGROUND

In a communication network, an operator can develop a capability open platform based on the existing communication resources, so as to open up the corresponding communication capabilities to an enterprise, an organization or an individual using the above platform. However, due to the relatively weak software development capability of the operator, the coverage of the above-mentioned capability open platform is limited, and it is impossible to provide the above-mentioned communication capabilities to local areas such as the municipal level and the county level.

In related technologies, an operator usually chooses to let service providers in various local areas develop the above communication resources and provide them for use by local customers, which leads to the situation that the operator needs to interface with a large number of service providers, and the difficulty of accessing, controlling and managing the overall communication resources increases greatly.

### SUMMARY

In view of this, the present disclosure provides a communication service system, an implementation method of a communication service, a device and a storage medium, so as to solve the shortcomings in related technologies.

In an implementation, the present disclosure is implemented by the following technical scheme.

According to a first aspect of embodiments of the present disclosure, a communication service system is provided, which includes a central control and management device and at least one edge cloud node. The central control and management device is configured to, in response to a communication service request initiated for a destination device, determine a target edge cloud node corresponding to the destination device among the at least one edge cloud node according to a preset resource scheduling strategy, and schedule the communication service request to the target edge cloud node. The target edge cloud node is configured to forward the received communication service request to an operator network, so that the operator network triggers an establishment of a communication connection between the central control and management device and the destination device based on the communication service request.

According to a second aspect of embodiments of the present disclosure, an implementation method of a communication service is provided, which is applied to a central control and management device, and includes: receiving a communication service request initiated for a destination device; determining a target edge cloud node corresponding to the destination device among at least one edge cloud node according to a preset resource scheduling strategy, and sending the communication service request to the target edge cloud node, so that the target edge cloud node forwards the received communication service request to an operator network, and the operator network triggers an establishment of a call connection between the central control and management device and the destination device based on the communication service request.

According to a third aspect of embodiments of the present disclosure, an implementation method of a communication service is provided, which is applied to a target edge cloud node. The target edge cloud node is a node corresponding to a destination device among at least one edge cloud node which is determined according to a preset resource scheduling strategy, and the implementation method includes: receiving a communication service request for the destination device which is sent by a central control and management device; forwarding the communication service request to an operator network, so that the operator network triggers an establishment of a call connection between the central control and management device and the destination device based on the communication service request.

According to a fourth aspect of embodiments of the present disclosure, a computer-readable storage medium is provided, which has a computer program stored thereon, where the program, when executed by a processor, implements steps of the methods as described in the second and third aspects.

According to a fifth aspect of embodiments of the present disclosure, an electronic device is provided, which includes a memory, a processor and a computer program stored in the memory and executable on the processor, where when the processor executes the program, steps of the methods as described in the second and third aspects is implemented.

It is to be understood that both the foregoing general description and the following detailed description are exemplary and illustrated only and are not restrictive of the present disclosure.

### BRIEF DESCRIPTION OF DRAWINGS

In order to more clearly illustrate a technical solution in an embodiment of the present disclosure or related technologies, the figures needed in the description of the embodiments or related technologies will be briefly introduced below. It is evident that the drawings in the following description are only some embodiments recorded in the present disclosure, and other drawings can be obtained according to these drawings for those of ordinary skill in the art.

FIG. 1 is a schematic architecture diagram of a distributed edge cloud provided by an exemplary embodiment of the present disclosure.

FIG. 2 is a schematic architecture diagram of a communication service system shown in an exemplary embodiment of the present disclosure.

FIG. 3A and FIG. 3B are schematic diagrams of multi-party interaction for implementing a payment notification based on a voice service shown in an exemplary embodiment of the present disclosure.

FIG. 4 is a flowchart of an implementation method of a communication service shown in an exemplary embodiment of the present disclosure.

FIG. 5 is a flowchart of another implementation method of a communication service shown in an exemplary embodiment of the present disclosure.

FIG. 6 is a schematic structural diagram of an electronic device shown in an exemplary embodiment of the present disclosure.

FIG. 7 is a schematic structural diagram of an implementation apparatus of a communication service shown in an exemplary embodiment of the present disclosure.

FIG. 8 is a schematic structural diagram of another implementation apparatus of a communication service shown in an exemplary embodiment of the present disclosure.

### DESCRIPTION OF EMBODIMENTS

Reference will now be made in detail to exemplary embodiments, examples of which are illustrated in the accompanying drawings. When the following description refers to the accompanying drawings, unless otherwise indicated, the same numbers in different accompanying drawings indicate the same or similar elements. The implementations described in the following exemplary embodiments do not represent all implementations consistent with the present disclosure. Rather, they are merely examples of apparatuses and methods consistent with some aspects of the present disclosure.

It should be noted that in other embodiments, the steps of the corresponding method may not necessarily be executed in the order shown and described in the present disclosure. In some other embodiments, the method may include more or less steps than those described in the present disclosure. In addition, a single step described in the present disclosure may be decomposed into multiple steps for description in other embodiments. Multiple steps described in the present disclosure may be combined into a single step for description in other embodiments. It should be understood that although the terms first, second, third, etc. may be used to describe various information in the present disclosure, such information should not be limited to these terms. These terms are only used to distinguish the same type of information from each other. For example, first information can also be referred as second information without departing from the scope of the present disclosure, and similarly, second information can also be referred as first information. Depending on the context, the word “if” as used herein can be interpreted as “in the case of” or “when” or “in response to a determination”.

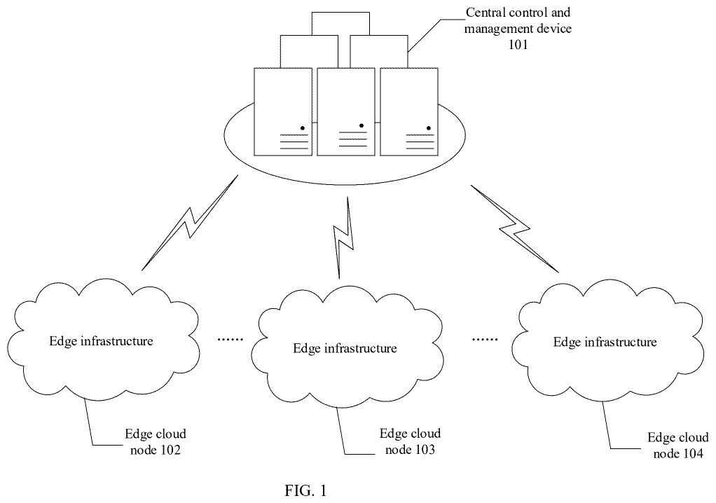

A distributed edge cloud is a cloud computing platform built on an edge infrastructure based on the core of cloud computing technology and the capability of edge computing. By performing tasks such as network forwarding, storage, computing and intelligent data analysis at the edge near a user, the distributed edge cloud can reduce the response delay and reduce the pressure on the cloud end. In order to understand the architecture of distributed edge cloud computing more intuitively, please refer to FIG. 1, which is a schematic architecture diagram of a distributed edge cloud provided by an exemplary embodiment of the present disclosure. The architecture of the distributed edge cloud may include a central control and management device 101 and a plurality of edge cloud nodes (for example, edge cloud node 102, edge cloud node 103 and edge cloud node 104), and the edge cloud is a relative concept. The edge cloud refers to a cloud computing platform that is relatively close to a terminal, or it is different from a central cloud or the traditional cloud computing platform. The central cloud or the traditional cloud computing platform can include a data center with large-scale resources located in a centralized manner, while the edge cloud nodes cover a wider network range, so they have the characteristic of being closer to the terminal. The resources of a single edge cloud node are relatively small, but the number of edge cloud nodes is large, and multiple edge cloud nodes constitute the components of the edge cloud.

The distributed edge cloud includes at least one edge cloud node (for example, edge cloud node 102, edge cloud node 103 and edge cloud node 104), and each edge cloud node includes a series of edge infrastructures, including but not limited to: a distributed data center (DC), a wireless computer room or cluster, a communication network of an operator, a core network device, a base station, an edge gateway, a home gateway, a computing device or a storage device and other edge devices and corresponding network environment, etc. It is explained here that the locations, capabilities and included infrastructure of different edge cloud nodes can be the same or different.

The central control and management device 101 takes the edge cloud nodes (such as the edge cloud node 102, the edge cloud node 103 and the edge cloud node 104) as controlled and managed objects, and uniformly controls and manages at least one edge cloud node in a network system in terms of resource scheduling, mirror management, instance control and management, operation and maintenance, network, security and so on, so as to put a cloud computing service in each edge cloud node for processing. For deployment implementation, the central control and management device 101 can be deployed in one or more cloud computing data centers, or it can be deployed in one or more traditional data centers, and the central control and management device 101 can also jointly form an edge cloud together with at least one edge cloud node it controls and manages.

In this embodiment, an edge cloud can be combined with a terminal and a central network such as the central cloud or the traditional cloud computing platform to form a network architecture of “cloud-edge-terminal three-body cooperation”. In this network architecture, tasks such as network forwarding, storage, computing and intelligent data analysis can be handled in respective edge cloud nodes (such as edge cloud node 102, edge cloud node 103 and edge cloud node 104). Because each edge cloud node is closer to the terminal, the response delay can be reduced, the pressure of the central cloud or the traditional cloud computing platform can be relieved, and the bandwidth cost can be reduced.

For an edge cloud node, it can provide various resources to outside, such as computing resources like CPU and GPU, storage resources like memory and hard disk, and network resources like bandwidth. In addition, the edge cloud node 102 can also create a corresponding instance according to an image, and provide various cloud computing services to outside through the instance. The image is a basic file needed to create an instance in the edge cloud node, such as the image file of the operating system, application, or operation configuration needed to provide cloud computing services for a user, and it can be a file that meets a requirement of computing deployment of the edge cloud node and is made in a certain format according to a specific series of files. In addition, image forms are various, such as a Virtual Machine (VM) image file, a docker image file or various types of application package files, etc. The image form may be related to the virtualization technology required for a cloud computing service, and this embodiment does not limit this. Corresponding to the image, the implementation form of the instance can be a virtual machine, a docker or an application program.

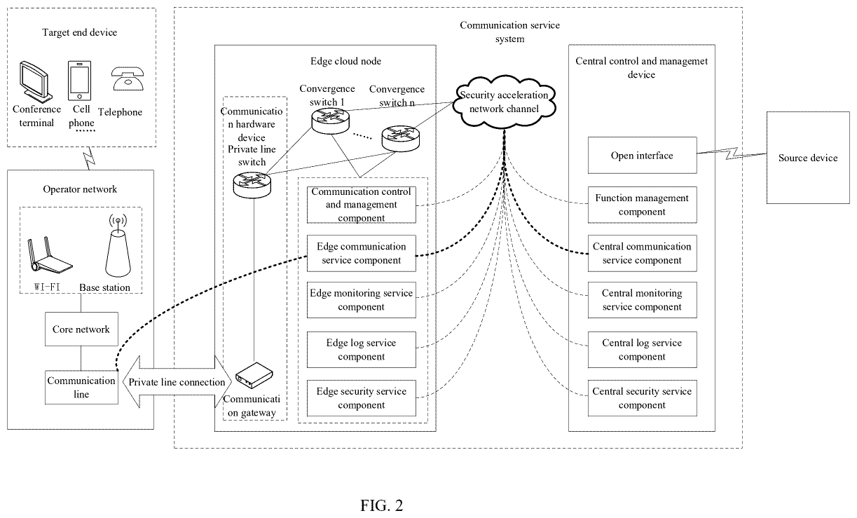

Next, a communication service system implemented based on the network architecture for cloud edge end in the present disclosure will be described with reference to FIG. 2, which is a schematic architecture diagram of a communication service system shown in an exemplary embodiment of the present disclosure. The communication service system includes a central control and management device and at least one edge cloud node.

The above central control and management device can be connected with the following source device. During the operation of the system, the central control and management device can be configured to, in response to a communication service request initiated for a destination device, determine a target edge cloud node corresponding to the destination device among the at least one edge cloud node according to a preset resource scheduling strategy, and schedule the communication service request to the target edge cloud node.

The target edge cloud node can be connected with the destination device through an operator network of the at least one edge cloud node (i.e., the edge infrastructure). During that operation of the system, the target edge cloud node can be configured to forward the received communication service request to the operator network, so that the operator network establishes a communication connection between the central control and management device and the destination device based on the communication service request.

The source device can be determined according to the actual situation of a customer (that is, a user of the source device). For example, when the customer belongs to an enterprise or an organization, the source device can be an electronic device equipped with a customer function platform oriented to the collective, and the electronic device can be a physical server containing an independent host or can be a virtual server carried by a host cluster, which is not limited by one or more embodiments of the present disclosure. When the customer is an individual, the source device can be an electronic device owned by the customer, such as a cell phone, a tablet device, a notebook computer, a personal digital assistant (PDAs), and a wearable device (such as smart glasses, a smart watch, etc.), which is not limited by one or more embodiments of the present disclosure. The destination device can be determined as a conference terminal, a cell phone, a telephone or a soundbox according to the communication mode provided by the end user (that is, the user of the destination device), which is not limited in the present disclosure.

Of course, in order to ensure the communication security between the central control and management device and the at least one edge cloud node, a security acceleration network channel can be established between them, as shown in FIG. 2, and the security acceleration network channel can be configured to send data of the central control and management device or the at least one edge cloud node to the other side. In an implementation, the security acceleration network channel can be represented as a physical transmission channel based on a private line, or a network transmission channel based on Internet technology, or a mixed channel formed based on the above two channels, which is not limited in the present disclosure.

The central control and management device may be configured with an API (Application Program Interface), so that the source device can control and manage the corresponding components in the central control and management device through the open interface.

The resource scheduling strategy can be formulated based on the dimension of geographical location to help the central control and management device determine the target edge cloud node.

In an embodiment, the central control and management device can query a user's home location corresponding to the destination device, and select an edge cloud node matching the user's home location from the at least one edge cloud node as the target edge cloud node. The matching rule may require that the geographical distance between the target edge cloud node and the user's home location is less than a preset range, in other words, the target edge cloud node may be a node among the at least one edge cloud node that is close to the location of the destination device. Therefore, the destination device can more efficiently assist the operator network connected with the target edge cloud node to establish the communication connection by virtue of the distance advantage with the target edge cloud node.

Of course, if the communication service request already carries specific edge cloud node information, the central control and management device can ignore the resource scheduling strategy and directly establish the communication connection with the target device through the edge cloud node corresponding to the edge cloud node information.

It can be understood that the establishment of the communication connection will be accompanied by cancellation, so in the case of interruption of the communication connection, the target edge cloud node can receive communication completion information returned by the operator network, and send the communication completion information to the central control and management device, and at the same time, the central control and management device can send the received communication completion information to the source device, so that a customer can confirm that the communication service has been completed in time. Of course, depending on the timing of interrupting the communication connection, the communication completion information can be further subdivided into situations such as a communication ending completely or a communication ending unexpectedly midway, so that the communication completion information can carry description information about such situations and the source device can determine the subsequent execution strategy according to the description information. For example, when the central control and management device receives the communication completion information indicating communication ending unexpectedly midway, it can initiate a communication service request for the destination device again.

The above communication connection is usually suitable for a scenario of a communication service between a real user and a central control and management device, but in some special situations, it is necessary to communicate with the real user in the case that there is a problem for the real user that the central control and management device can't answer. At this time, the central control and management device can establish a connection with the source device on the basis of the communication connection, so that the communication connection is changed from the original “central control and management device-target edge cloud node-operator network-target end device” to “source device-central control and management device-target edge cloud node-operator network-target end device”, so that a customer can directly communicate with a user through the source device, thus ensuring the successful completion of a related communication service.

In order to ensure the interconnection between the operator network and the target edge cloud node, a communication hardware device can be deployed in the target edge cloud node or the local network where the target edge cloud node is located, and the communication hardware device can be configured to establish the communication connection between the target edge cloud node and the operator network. The communication hardware device can be connected with a communication line in the operator's network through a private line, and the communication hardware device can include a communication gateway and a private line switch. On the one hand, the communication gateway can be configured to convert communication data between two protocols, such as a traditional communication protocol and an IP network related protocol, thus ensuring the normal transmission of the communication data between the communication service system and the operator's network. On the other hand, the private line switch can be configured as the only device in the target edge cloud node that connects to the communication gateway, so as to uniformly receive or send communication data for the communication gateway or other aggregation switches in the target edge cloud node (corresponding to aggregation switch 1 to aggregation switch n in FIG. 2, where n is a positive integer).

The communication hardware device in the present disclosure can be adjusted accordingly based on an actual application scenario.

In an embodiment, because the specific service included in the communication service can be determined according to the communication resources actually provided by the operator network, the communication service can be a voice service and the communication connection can be a voice call connection in the case that the operator network provides resources related to a voice call. Correspondingly, the communication hardware device can be a voice hardware device, which can include a voice gateway and a private line switch, and the voice gateway can be configured to convert the corresponding protocols of voice data in the operator network and the edge cloud network.

Next, the present disclosure will illustrate in turn the target edge cloud node and each group of the central control and management device shown in FIG. 2. Any component can be regarded as a functional logic implemented by a virtual machine or a server deployed in the device (i.e., the central control and management device or any one of the edge cloud nodes) through programming technology, or an independent physical module storing the corresponding functional logic, which is not limited in the present disclosure.
1. A function management component deployed on the central control and management device: can be configured to manage any component on the central control and management device or any one of the edge cloud nodes. For example, when a customer requests to temporarily close and maintain the following central monitoring service component, the central monitoring service component can be closed or deleted through the function management component to disconnect the component from other components until the function management component restarts or adds the central monitoring service component.
2. A central communication service component deployed on the central control and management device and an edge communication service component deployed on at least one edge cloud node: are two important components in the communication service system. The central communication service component can be configured to establish, with the edge communication service component, a first communication segment between the central control and management device and the target edge cloud node in the communication connection, and send a communication content provided by a source device that initiates the communication service request or a communication content generated according to an original content provided by the source device to the target edge cloud node through the first communication segment. The edge communication service component can be configured to cooperate with the central communication service component to establish the first communication segment and receive the communication content through the first communication segment; and establish, with the operator network, a second communication segment between the edge cloud node where it is located and the operator network in the communication connection, and send the communication content to the operator network through the second communication segment, so that the communication content is forwarded to the destination device through the operator network. The combination of the first communication segment and the second communication segment implements the transmission of the communication data on the path of “central control and management device-target edge cloud node-operator network-target end device”. At the same time, the target edge cloud node can be deployed with an edge communication service component cluster to improve the communication service execution efficiency of the corresponding edge cloud node. Of course, other components in the edge cloud node or the central control and management device can also apply similar technologies, which will not be repeated in the present disclosure again.

In addition, in different communication service scenarios, the specific operations implemented by the central communication service component and the edge communication service component are different. Taking a voice service as an example, the central control and management device is deployed with a central communication service component, and the target edge cloud node can be deployed with an edge voice service component, where the central communication service component and/or the edge voice service component can include a load balancing sub-component, a signaling control sub-component, a media processing sub-component, a log management sub-component and a security encryption sub-component. The load balancing sub-component can perform the load balancing on the voice service request received by the device where the component is located, so as to improve the response speed and overall performance of the voice service system for the voice service request. The signaling control sub-component and the media processing sub-component of the central communication service component can be configured to perform processes such as signaling, media establishment, connection and release between the central control and management device and the target edge cloud node, and the signaling control sub-component and the media processing sub-component of the target edge cloud node can be configured to receive controlling and managing, monitoring and management from the central communication service component, and perform processes such as signaling, media establishment, connection and release between the operator network and the target edge cloud node, so as to implement incoming call and outgoing call of the target end device or the source device about the voice service. The log management sub-component can record the relevant information of a voice service request received by the component where it is located, so as to facilitate the subsequent high-precision inquiry of a customer. The security encryption sub-component can further encrypt the content of voice service request to ensure the security of voice call connection.
3. A communication control and management component deployed by at least one edge cloud node: can be configured to locally control and manage an edge cloud node where it is located and record offline data in the case that the edge cloud node loses its connection with the central control and management device, as to ensure the normal operation of a communication service involved within the edge cloud node. At the same time, the communication control and management component can synchronize the offline data with the central control and management device in the case that the connection with the central control and management device is restored, and the central control and management device will control and manage the edge cloud node again. In an implementation, the communication control and management component supports the capabilities of automatic migration when the device where it is located is down, disk IO speed limit, data cache, etc., and can effectively help the communication service component to achieve high availability. It can be understood that in the case of the disconnection, the central control and management unit can quickly perceive and quickly schedule the corresponding communication service to other available channels, so as to ensure the usage experience of the target end device in the communication link.
4. A central monitoring service component deployed on the central control and management device and an edge monitoring service component deployed on at least one edge cloud node: the edge monitoring service component can be configured to execute a corresponding alarm operation and send the generated alarm information to the central control and management device in the case that any component in the edge cloud node where it is located is abnormal; the central monitoring service component can be configured to analyze the received alarm information, and control a corresponding edge cloud node to execute a corresponding abnormal resolution measure based on an analysis result. Compared with the following central security service component or edge security service component, the central monitoring service component and the edge monitoring service component pay more attention to solving an internal problem caused by abnormal software logic in the communication service system.
5. A central log service component deployed on the central control and management device and an edge log service component deployed on at least one edge cloud node: the edge log service component can be configured to collect edge component data of each component in the edge cloud node where it is located and send it to the central log service component; the central log service component can be configured to analyze the received edge component data to obtain statistical information of each component in the corresponding edge cloud node. The edge component data may include various performance and index data representing a communication service. Still taking a voice service as an example, the edge component data may be at least one of the following: current service bandwidth flow, current service operation, IO load of each instance, operation of each component, call records, etc. Meanwhile, the central log service component may perform related logic such as data analysis, billing or monitoring on the edge component data, which is not limited in the present disclosure.
6. A central security service component deployed on central control and management device and an edge security service component deployed on at least one edge cloud node: the edge security service component can be configured to detect a network security condition of each component in the edge cloud node where it is located and send a detection result to the central security service component; the central security service component can be configured to determine a security policy according to the received detection result, and send the security policy to the edge security service component. Compared with the central monitoring service component or the edge monitoring service component, the central security service component and the edge security service component pay more attention to avoiding or reducing the loss of the communication service system itself caused by external utilization traffic attacks or network vulnerabilities of the communication service system.

It should be noted that since the source device can control each component in the central control and management device according to the open interface, and each component in the central control and management device is connected with a component in the target edge cloud node through the security acceleration network channel, the source device can indirectly control the corresponding component in the target edge cloud node through the component of the central control and management device, so that the source device can implement the ability to control and manage any component in the overall communication service system.

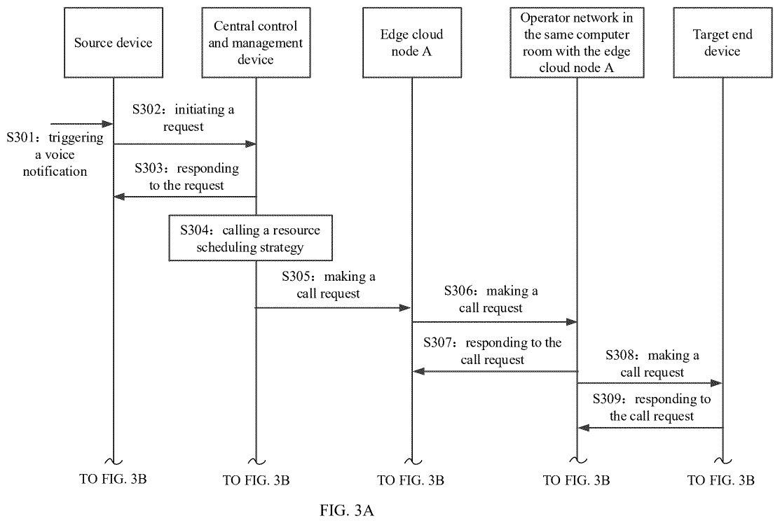

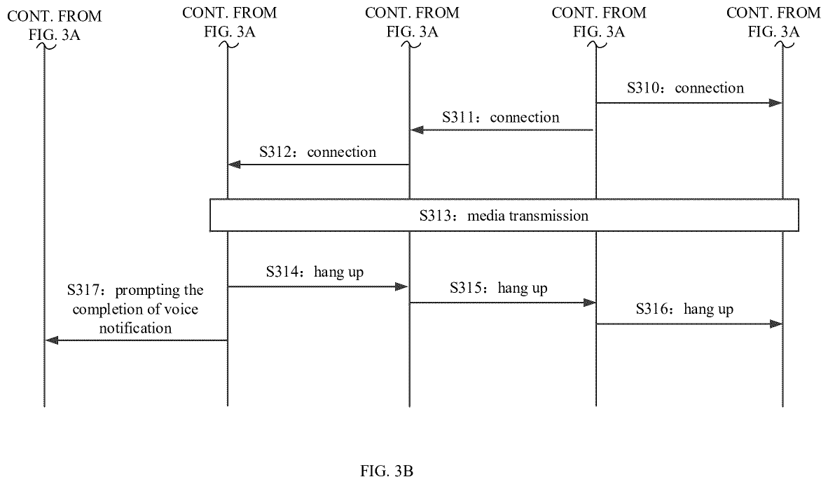

Next, the scheme of the present disclosure will be explained by taking the scene where a customer notifies a user of payment through a voice service as an example. Please refer to FIG. 3, which is a schematic diagram of multi-party interaction for implementing payment notification based on a voice service which is provided by an exemplary embodiment of the present disclosure. The following steps exist in the figure:
S301, triggering a voice notification of a source device.

In an embodiment, it is assumed that the source device is a customer function platform of an insurance company, and at this time, it is found in the customer function platform that the insurance payment time of a user A has reached the set time, so it is necessary to remind the user A to pay in time through the voice notification.

S302: initiating, by the source device, a voice service request to a central control and management device.

In an embodiment, the customer function platform initiates the voice service request to the central control and management device, where the voice service request carries identity information, contact information and payment time of the user A.

S303: responding, by the central control and management device, to the voice service request initiated by the source device.

In an embodiment, after receiving the voice service request, the central control and management device calls a pre-recorded voice template, and fills the template with the identity information, the contact information and the payment time of the user A to generate the corresponding notification content, such as: “Dear ‘User A’, your insurance in xxx Company has expired on ‘payment time’, please pay in time.” (The content in the ‘’ symbol can be defined as fill-in content, and the other content uses the content in the voice template).

S304: calling, by the central control and management device, a resource scheduling strategy to determine an edge cloud node A.

In an embodiment, the central control and management device can query the user's home location Z corresponding to the contact information through a built-in scheduling center, and at the same time, query and find that the user's home location Z is deployed in the edge cloud node A.

S305: making, by the central control and management device, a call request to the edge cloud node A.

S306: making, by the edge cloud node A, a call request to an operator network in the same computer room.

S307: responding, by the operator network, to the call request of the edge cloud node A.

In an embodiment, the central control and management device makes a call request to the edge cloud node A, and at the same time, the edge cloud node A sends the call request to the operator network, and the operator network responds to the call request.

S308: making, by the operator network, a call request to a target end device.

S309: responding, by the target end device, to the call request of the operator network.

In an embodiment, the operator network then sends the received call request to the target end device corresponding to the contact information (assuming that the target end device is a cell phone of the user A), and at this time, the target end device responds to the call request and rings to inform the user A to answer.

S310: notifying, by the operator network, the target end device that the response of the target end device has been received.

S311: notifying, by the operator network, the edge cloud node A that the response of the target end device has been received.

S312: notifying, by the edge cloud node A, the central control and management device that the response of the target end device has been received.

In an embodiment, after the user A answers the call, the operator network can inform the target end device that the response of the target end device has been received, and at the same time, inform the central control and management device that the response of the target end device has been received through the edge cloud node A.

S313: transmitting media between the central control and management device and the target end device.

In an embodiment, a voice call connection is formally established between the central control and management device and the target end device, and media information (including the notification content) is transmitted to each other through this connection.

S314: notifying, by the central control and management device, the edge cloud node A to hang up the voice call.

S315, notifying, by the edge cloud node A, the operator network to hang up the voice call.

S316: notifying, by the operator network, the target end device to hang up the voice call.

In an embodiment, after the user A finishes listening to the notification content and makes a confirm, the central control and management device can choose to actively hang up the voice call connection, so that a hang-up notice is transmitted to the operator network through the edge cloud node A, so that the operator network hangs up the voice call connection with the target end device.

S317: notifying, by the central control and management device, the source device of the completion of voice notification.

In an embodiment, after the voice call connection is successfully hung up, the customer function platform can receive a voice completion notification from the central control and management device because the notification content has been played.

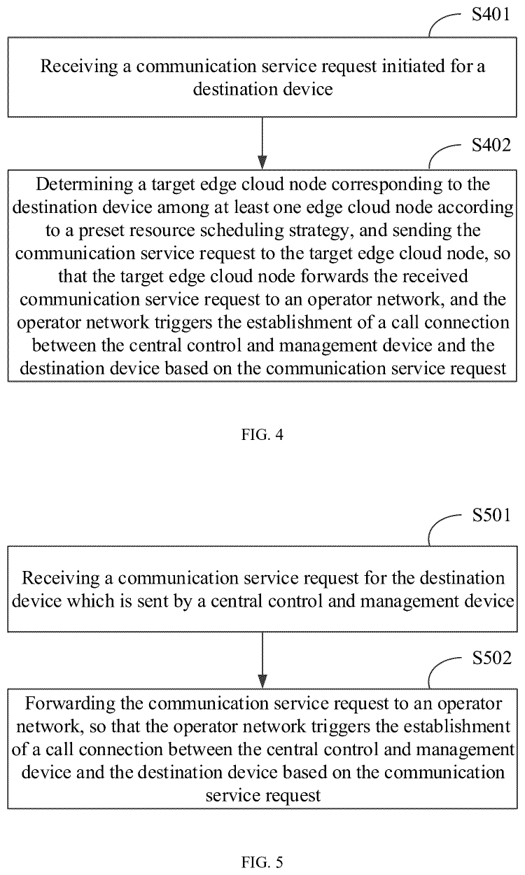

Next, the technical scheme of the present disclosure will be described in combination with the embodiment shown in FIG. 4. FIG. 4 is a flowchart of an implementation method of a communication service shown in an exemplary embodiment of the present disclosure. As shown in FIG. 4, the method is applied to a central control and management device, and may include the following steps: S401, receiving a communication service request initiated for a destination device. S402: determining a target edge cloud node corresponding to the destination device among at least one edge cloud node according to a preset resource scheduling strategy, and sending the communication service request to the target edge cloud node, so that the target edge cloud node forwards the received communication service request to an operator network, and the operator network triggers an establishment of a call connection between the central control and management device and the destination device based on the communication service request.

As mentioned above, the determining a target edge cloud node corresponding to the destination device among at least one edge cloud node according to a preset resource scheduling strategy includes: querying a user's home location corresponding to the destination device; selecting an edge cloud node that matches the user's home location from the at least one edge cloud node as the target edge cloud node.

As mentioned above, the communication service is a voice service and the communication connection is a voice call connection.

As mentioned above, a voice hardware device is deployed in the target edge cloud node or in a local network where the target edge cloud node is located, and the voice hardware device is configured to establish a voice call connection between the target edge cloud node and the operator network.

As mentioned above, the central control and management device is deployed with a central communication service component, and the target edge cloud node is deployed with an edge communication service component. The central communication service component is configured to establish, with the edge communication service component, a first communication segment between the central control and management device and the target edge cloud node in the communication connection, and send a communication content provided by a source device that initiates the communication service request or a communication content generated according to an original content provided by the source device to the target edge cloud node through the first communication segment.

The edge communication service component is configured to establish the first communication segment in cooperation with the central communication service component and receive the communication content through the first communication segment; and establish, with the operator network, a second communication segment between the edge cloud node where it is located and the operator network in the communication connection, and send the communication content to the operator network through the second communication segment so as to be forwarded to the destination device by the operator network.

As mentioned above, the at least one edge cloud node is deployed with a communication control and management component. The communication control and management component is configured to locally control and manage an edge cloud node where it is located and record offline data in the case that the edge cloud node loses its connection with the central control and management device; and synchronize the offline data with the central control and management device in the case that the connection with the central control and management device is restored.

As mentioned above, the central control and management device is deployed with a central monitoring service component, and the at least one edge cloud node is deployed with an edge monitoring service component. The edge monitoring service component is configured to execute a corresponding alarm operation and send the generated alarm information to the central control and management device in the case that any component in the edge cloud node where it is located is abnormal. The central monitoring service component is configured to analyze the received alarm information, and control a corresponding edge cloud node to execute a corresponding abnormal resolution measure according to an analysis result.

For the above contents, please refer to the contents of the embodiments in FIG. 2 FIG. 3, and the description will not be repeated here.

Next, the technical scheme of the present disclosure will be described in combination with the embodiment shown in FIG. 5. FIG. 5 is a flowchart of another implementation method of communication service shown in an exemplary embodiment of the present disclosure. As shown in FIG. 5, this method is applied to a target edge cloud node, and the target edge cloud node is a node corresponding to a destination device among at least one edge cloud node which is determined according to a preset resource scheduling strategy, and the method may include the following steps:
S501: receiving a communication service request for the destination device which is sent by a central control and management device.
S502: forwarding the communication service request to an operator network, so that the operator network triggers an establishment of a call connection between the central control and management device and the destination device based on the communication service request.

As mentioned above, the determining of the target edge cloud node corresponding to the destination device among the at least one edge cloud node according to the preset resource scheduling strategy includes: querying a user's home location corresponding to the destination device; selecting an edge cloud node that matches the user's home location from the at least one edge cloud node as the target edge cloud node.

As mentioned above, the communication service is a voice service and the communication connection is a voice call connection.

As mentioned above, a voice hardware device is deployed in the target edge cloud node or in a local network where the target edge cloud node is located, and the voice hardware device is configured to establish a voice call connection between the target edge cloud node and the operator network.

As mentioned above, the central control and management device is deployed with a central communication service component, and the target edge cloud node is deployed with an edge communication service component. The central communication service component is configured to establish, with the edge communication service component, a first communication segment between the central control and management device and the target edge cloud node in the communication connection, and send a communication content provided by a source device that initiates the communication service request or a communication content generated according to an original content provided by the source device to the target edge cloud node through the first communication segment.

The edge communication service component is configured to establish the first communication segment in cooperation with the central communication service component and receive the communication content through the first communication segment; and establish, with the operator network, a second communication segment between the edge cloud node where it is located and the operator network in the communication connection, and send the communication content to the operator network through the second communication segment so as to be forwarded to the destination device by the operator network.

As mentioned above, the at least one edge cloud node is deployed with a communication control and management component. The communication control and management component is configured to locally control and manage an edge cloud node where it is located and record offline data in the case that the edge cloud node loses its connection with the central control and management device; and synchronize the offline data with the central control and management device in the case that the connection with the central control and management device is restored.

As mentioned above, the central control and management device is deployed with a central monitoring service component, and the at least one edge cloud node is deployed with an edge monitoring service component. The edge monitoring service component is configured to execute a corresponding alarm operation and send the generated alarm information to the central control and management device in the case that any component in the edge cloud node where it is located is abnormal. The central monitoring service component is configured to analyze the received alarm information, and control a corresponding edge cloud node to execute a corresponding abnormal resolution measure according to an analysis result.

For the above contents, please refer to the contents of the embodiment in FIG. 2-FIG. 3, and the description will not be repeated here.

From the above embodiments, it can be seen that the implementation method of a communication service in the present disclosure makes up for the lack of coverage of the capability open platform provided by an operator by integrating a communication service with a cloud-edge architecture. At the same time, the central control and management device controls and manages the edge cloud node, so that the communication resource of the operator can be uniformly controlled by the central control and management device, and the central control and management device can uniformly interface with, and control and manage customers at various locations, thus avoiding the operator from separately interfacing with different service providers in different regions, and greatly reducing the management and operation and maintenance difficulties of the operator.

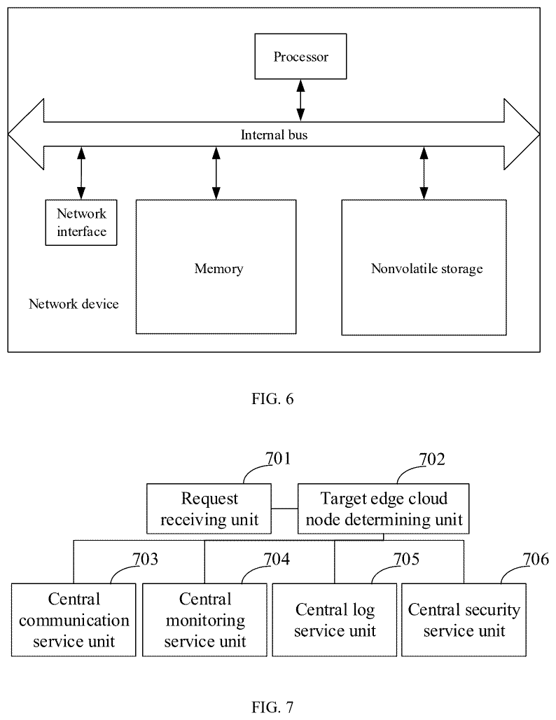

FIG. 6 is a schematic structural diagram of an electronic device in an exemplary embodiment. Please refer to FIG. 6, on the hardware level, the electronic device includes a processor, an internal bus, a network interface, a memory, a nonvolatile storage and, of course, other required hardware. The processor reads the corresponding computer program from the nonvolatile storage into the memory and then runs it, thus forming an implementation apparatus of a communication service on the logical level. Of course, besides the software implementation, the present disclosure does not exclude other implementations, such as logic devices or a combination of software and hardware, etc., that is to say, the execution subject of the following processing flow is not limited to each logic unit, but also can be a hardware or a logic device.

Corresponding to the aforementioned embodiment of the communication service implementation method, the present disclosure also provides an embodiment of an implementation apparatus of a communication service.

Please refer to FIG. 7, which is a schematic structural diagram of an implementation apparatus of a communication service shown in an exemplary embodiment. As shown in FIG. 7, in the software implementation, the apparatus is applied to the central control and management device, and the apparatus may include a request receiving unit 701, configured to receive a communication service request initiated for a destination device; a target edge cloud node determining unit 702, configured to determine a target edge cloud node corresponding to the destination device among at least one edge cloud node according to a preset resource scheduling strategy, and send the communication service request to the target edge cloud node, so that the target edge cloud node forwards the received communication service request to an operator network, and the operator network triggers the establishment of a call connection between the central control and management device and the destination device based on the communication service request.

In an embodiment, the target edge cloud node determining unit 702 is specifically configured to query a user's home location corresponding to the destination device; select an edge cloud node that matches the user's home location from the at least one edge cloud node as the target edge cloud node.

In an implementation, the communication service is a voice service and the communication connection is a voice call connection.

In an implementation, the apparatus further includes a central communication service unit 703, which is configured to establish, with the central control and management device, a second communication segment between the central control and management device and the target edge cloud node in the communication connection.

In an implementation, the apparatus further includes a central monitoring service unit 704, which is configured to analyze the received alarm information, and control a corresponding edge cloud node to execute a corresponding abnormal resolution measure according to an analysis result, where the alarm information is generated in the case that any component of the edge cloud node is abnormal.

In an implementation, the apparatus further includes a central log service unit 705, which is configured to analyze the received edge component data to obtain statistical information of each component in the corresponding edge cloud node, and the edge component data is obtained by the at least one edge cloud node through collecting data from each component.

In an implementation, the apparatus further includes a central security service unit 706, which is configured to determine a security policy according to the received detection result, and send the security policy to a corresponding edge cloud node, where the detection result is obtained by the at least one edge cloud node through detecting a network security condition of each component of itself.

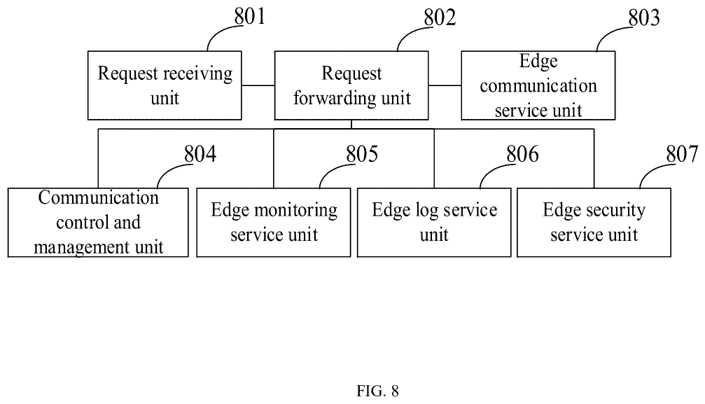

Please refer to FIG. 8, which is a schematic structural diagram of another implementation apparatus of a communication service shown in an exemplary embodiment. As shown in FIG. 8, in the software implementation, the apparatus is applied to a target edge cloud node, and the target edge cloud node is a node corresponding to a destination device among at least one edge cloud node which is determined according to a preset resource scheduling strategy, and the apparatus may include a request receiving unit 801 configured to receive a communication service request sent by a central control and management device for the destination device; a request forwarding unit 802, configured to forward the communication service request to an operator network, so that the operator network triggers the establishment of a call connection between the central control and management device and the destination device based on the communication service request.

In an implementation, the communication service is a voice service and the communication connection is a voice call connection.

In an embodiment, a voice hardware device is deployed in the target edge cloud node or in a local network where the target edge cloud node is located, and the voice hardware device is configured to establish a voice call connection between the target edge cloud node and the operator network.

In an implementation, the apparatus further includes an edge communication service unit 803, which is configured to establish, with the central control and management device, a second communication segment between the central control and management device and the target edge cloud node in the communication connection; and establish, with the operator network, a third communication segment between the edge cloud node where it is located and the operator network in the communication connection.

In an implementation, the apparatus further includes a communication control and management unit 804, which is configured to locally control and manage an edge cloud node where it is located and record offline data in the case that the edge cloud node loses its connection with the central control and management device; and synchronize the offline data with the central control and management device in the case that the connection with the central control and management device is restored.

In an implementation, the apparatus further includes an edge monitoring service unit 805, which is configured to execute a corresponding alarm operation and send the generated alarm information to the central control and management device in the case that any component in the edge cloud node where it is located is abnormal, so that the central control and management device can analyze the received alarm information, and control a corresponding edge cloud node to execute a corresponding abnormal resolution measure according to an analysis result.

In an implementation, the apparatus further includes an edge log service unit 806, which is configured to collect edge component data of each component in the edge cloud node where it is located and send it to a central control and management device, so that the central control and management device can analyze the edge component data to obtain statistical information of each component in the corresponding edge cloud node.

In an implementation, the apparatus further includes an edge security service unit 807, which is configured to detect a network security condition of each component in the edge cloud node where it is located, and send a detection result to the central control and management device, so that the central control and management device can determine a security policy according to the received detection result, and send the security policy to the edge security service unit.

The implementation process of the function and role of each unit in the above-mentioned apparatus is detailed in the implementation process of the corresponding steps in the above-mentioned method, and will not be repeated here.

For the apparatus embodiment, because it basically corresponds to the method embodiment, it is necessary to refer to part of the description of the method embodiment for the relevant points. The apparatus embodiment described above are only schematic, in which the units described as separate components may or may not be physically separated, and the component(s) displayed as a unit may or may not be a physical unit, that is, they may be located in one place or distributed to multiple network units. Some or all of the modules can be selected according to the actual needs to achieve the purpose of the present disclosure. Those of ordinary skill in the art can understand and implement it without a creative work.

Embodiments of the subject matter and functional operation described in the present disclosure can be implemented in a digital electronic circuit, a tangibly embodied computer software or firmware, a computer hardware including the structure and its structural equivalent disclosed in the present disclosure, or a combination of one or more of them. Embodiments of the subject matter described in the present disclosure can be implemented as one or more computer programs, that is, one or more modules of computer program instruction(s) encoded on a tangible non-transitory program carrier which are executed by a data processing apparatus or control the operation of a data processing apparatus. Alternatively or additionally, the program instruction may be encoded on an artificially generated propagation signal, such as machine-generated electrical, optical or electromagnetic signal, which is generated to encode and transmit information to an appropriate receiver device for execution by a data processing apparatus. A computer storage medium may be a machine-readable storage device, a machine-readable storage substrate, a random or serial access memorizer device, or a combination of one or more of them.

The processes and logic flow described in the present disclosure can be executed by one or more programmable computers executing one or more computer programs to perform a corresponding function by operating according to input data and generating an output. The processing and logic flow can also be performed by a dedicated logic circuit, such as an FPGA (Field Programmable Gate Array) or an ASIC (Application Specific Integrated Circuit), and the apparatus can also be implemented as a dedicated logic circuit.

A computer suitable for executing a computer program includes, for example, a general-purpose and/or special-purpose microprocessor, or any other type of central processing unit. Generally, the central processing unit will receive an instruction and data from a read-only memory and/or a random-access memory. Basic components of a computer include a central processing unit for implementing or executing an instruction and one or more memory devices for storing an instruction and data. Generally, the computer will also include one or more mass storage devices for storing data, such as a magnetic disk, a magneto-optical disk or an optical disk, or the computer will be operatively coupled with such mass storage device to receive data from or transmit data to it, or both. However, it is not necessary for the computer to have such device. Furthermore, the computer may be embedded in another device, such as a mobile phone, a personal digital assistant (PDA), a mobile audio or video player, a game console, a global positioning system (GPS) receiver, or a portable storage device such as a universal serial bus (USB) flash drive, to name a few.

A computer-readable medium suitable for storing a computer program instruction and data include all forms of nonvolatile memory, media and a memory device, including, for example, a semiconductor memorizer device (such as EPROM, EEPROM and a flash memorizer device), a magnetic disk (such as internal hard disk or removable disk), a magneto-optical disk, and CD ROM and a DVD-ROM disk. The processor and the memory may be supplemented by or incorporated into a dedicated logic circuit.

In the technical scheme provided in the present disclosure, because the network coverage of an edge cloud node is relatively wider, network resources of an operator can be provided to a customer in local areas such as the municipal level and the county level, which makes up for the defect of insufficient coverage of a capability open platform provided by the operator. At the same time, the central control and management device controls and manages the edge cloud node, so that communication resources of the operator can be uniformly controlled by the central control and management device, and the central control and management device can uniformly interface with, and control and manage customers at various locations, thus avoiding the operator from interfacing with different service providers in different regions, and greatly reducing the management and operation and maintenance difficulties of the operator.

Although the present disclosure contains many specific implementation details, these should not be interpreted as limiting the scope of any invention or claimed scope, but mainly used to describe characteristics of specific embodiments of a specific invention. Some features described in multiple embodiments in the present disclosure can also be combined in a single embodiment. On the other hand, various features described in a single embodiment can also be implemented separately or in any suitable sub-combination in multiple embodiments. Furthermore, although the feature may function in certain combinations as described above and even be claimed as such at first, one or more features from the claimed combination may be removed from the combination in some cases, and the claimed combination may point to a sub-combination or a variation of the sub-combination.

Similarly, although operations are depicted in a particular order in the drawings, this should not be construed as requiring that these operations be performed in the particular order shown or sequentially, or that all illustrated operations be performed to achieve a desired result. In some cases, multitasking and parallel processing may be beneficial. Furthermore, the separation of various system modules and components in the above embodiments should not be understood as requiring such separation in all embodiments, and it should be understood that the described program components and systems can generally be integrated together in a single software product or packaged into multiple software products.

Thus, specific embodiments of the subject matter have been described. Furthermore, the processes depicted in the drawings are not necessarily in the specific order or sequential order shown to achieve the desired result. In some implementations, multitasking and parallel processing may be advantageous.

The above is only the preferred embodiment of the present disclosure, and it is not used to limit the present disclosure. Any modification, equivalent substitution, improvement, etc. made within the spirit and principle of the present disclosure should be included in the scope of protection of the present disclosure.

1. A communication service system, comprising: a central control and management device and at least one edge cloud node, wherein
the central control and management device is configured to, in response to a communication service request initiated for a destination device, determine a target edge cloud node corresponding to the destination device among the at least one edge cloud node according to a preset resource scheduling strategy, and schedule the communication service request to the target edge cloud node;
the target edge cloud node is configured to forward the received communication service request to an operator network, so that the operator network triggers an establishment of a communication connection between the central control and management device and the destination device based on the communication service request.

2. The system according to claim 1, wherein the determine a target edge cloud node corresponding to the destination device among the at least one edge cloud node according to a preset resource scheduling strategy comprises:
query a user's home location corresponding to the destination device;
select an edge cloud node that matches the user's home location from the at least one edge cloud node as the target edge cloud node.

3. The system according to claim 1, wherein the communication service is a voice service and the communication connection is a voice call connection.

4. The system according to claim 3, wherein a voice hardware device is deployed in the target edge cloud node or in a local network where the target edge cloud node is located, and the voice hardware device is configured to establish a voice call connection between the target edge cloud node and the operator network.

5. The system according to claim 1, wherein the central control and management device is deployed with a central communication service component, and the target edge cloud node is deployed with an edge communication service component;
the central communication service component is configured to establish, with the edge communication service component, a first communication segment between the central control and management device and the target edge cloud node in the communication connection, and send a communication content provided by a source device that initiates the communication service request or a communication content generated according to an original content provided by the source device to the target edge cloud node through the first communication segment;
the edge communication service component is configured to establish the first communication segment in cooperation with the central communication service component and receive the communication content through the first communication segment; and establish, with the operator network, a second communication segment between the edge cloud node where the edge communication service component is located and the operator network in the communication connection, and send the communication content to the operator network through the second communication segment so as to be forwarded to the destination device by the operator network.

6. The system according to claim 1, wherein the at least one edge cloud node is deployed with a communication control and management component; and the communication control and management component is configured to:
locally control and manage an edge cloud node where the communication control and management component is located and record offline data in the case that the edge cloud node loses its connection with the central control and management device; and
synchronize the offline data with the central control and management device in the case that the connection with the central control and management device is restored.

7. The system according to claim 1, wherein the central control and management device is deployed with a central monitoring service component, and the at least one edge cloud node is deployed with an edge monitoring service component;
the edge monitoring service component is configured to execute a corresponding alarm operation and send the generated alarm information to the central control and management device in the case that any component in the edge cloud node where the edge monitoring service component is located is abnormal;
the central monitoring service component is configured to analyze the received alarm information, and control a corresponding edge cloud node to execute a corresponding abnormal resolution measure according to an analysis result.

8. The system according to claim 1, wherein the central control and management device is deployed with a central log service component, and the at least one edge cloud node is deployed with an edge log service component;
the edge log service component is configured to collect edge component data of each component in the edge cloud node where the edge log service component is located and send it to the central log service component;
the central log service component is configured to analyze the received edge component data to obtain statistical information of each component in the corresponding edge cloud node.

9. The system according to claim 1, wherein the central control and management device is deployed with a central security service component, and the at least one edge cloud node is deployed with an edge security service component;
the edge security service component is configured to detect a network security condition of each component in the edge cloud node where the edge security service component is located, and send a detection result to the central security service component;
the central security service component is configured to determine a security policy according to the received detection result and send the security policy to the edge security service component.

10. An implementation method of a communication service, which is applied to central control and management device, comprising:
receiving a communication service request initiated for a destination device;
determining a target edge cloud node corresponding to the destination device among at least one edge cloud node according to a preset resource scheduling strategy, and sending the communication service request to the target edge cloud node, so that the target edge cloud node forwards the received communication service request to an operator network, and the operator network triggers an establishment of a call connection between the central control and management device and the destination device based on the communication service request.

11. An implementation method of a communication service, which is applied to a target edge cloud node, wherein the target edge cloud node is a node corresponding to a destination device among at least one edge cloud node which is determined according to a preset resource scheduling strategy, and the implementation method comprises:
receiving a communication service request for the destination device which is sent by a central control and management device;
forwarding the communication service request to an operator network, so that the operator network triggers an establishment of a call connection between the central control and management device and the destination device based on the communication service request.

12. A non-transitory computer-readable storage medium having a computer program stored thereon, wherein the computer program, when executed by a processor, implements steps of the method according to claim 10.

13. An electronic device, comprising a memory, a processor and a computer program stored in the memory and executable on the processor, wherein when the processor executes the computer program, steps of the method according to claim 10 are implemented.

14. A non-transitory computer-readable storage medium having a computer program stored thereon, wherein the computer program, when executed by a processor, implements steps of the method according to claim 11.

15. An electronic device, comprising a memory, a processor and a computer program stored in the memory and executable on the processor, wherein when the processor executes the computer program, steps of the method according to claim 11 are implemented.

16. The implementation method of the communication service according to claim 10, wherein the determining a target edge cloud node corresponding to the destination device among at least one edge cloud node according to a preset resource scheduling strategy comprises:
querying a user's home location corresponding to the destination device;
selecting an edge cloud node that matches the user's home location from the at least one edge cloud node as the target edge cloud node.

17. The implementation method of the communication service according to claim 10, wherein the central control and management device is deployed with a central communication service component and the target edge cloud node is deployed with an edge communication service component, the implementation method further comprises:
establishing, with the edge communication service component, a first communication segment between the central control and management device and the target edge cloud node in the call connection; and
sending a communication content provided by a source device that initiates the communication service request or a communication content generated according to an original content provided by the source device to the target edge cloud node through the first communication segment.

18. The implementation method of the communication service according to claim 10, wherein the central control and management device is deployed with a central monitoring service component, and the at least one edge cloud node is deployed with an edge monitoring service component, the implementation method further comprises:
analyzing alarm information sent by the edge monitoring service component in the case that any component in the edge cloud node where the edge monitoring service component is located is abnormal; and
controlling a corresponding edge cloud node to execute a corresponding abnormal resolution measure according to an analysis result.

19. The implementation method of the communication service according to claim 11, wherein the central control and management device is deployed with a central communication service component and the target edge cloud node is deployed with an edge communication service component, the implementation method further comprises:
establishing a first communication segment in cooperation with the central communication service component and receiving a communication content through the first communication segment; and
establishing, with the operator network, a second communication segment between the target edge cloud node and the operator network in the call connection; and
sending the communication content to the operator network through the second communication segment so as to be forwarded to the destination device by the operator network.

20. The implementation method of the communication service according to claim 11, wherein the target edge cloud node is deployed with a communication control and management component and the implementation method further comprises:
locally controlling and managing the target edge cloud node and recording offline data in the case that the target edge cloud node loses its connection with the central control and management device; and
synchronizing the offline data with the central control and management device in the case that the connection with the central control and management device is restored.
